(19) United States
(12) Patent Application Publication
(10) Pub. No.: US 2006/0215950 A1
(43) Pub. Date: Sep. 28, 2006

(54) Integrated optical systems for generating an array of beam outputs

(76) Inventors: John Haig Marsh, Glasgow (GB); Stephen Najda, Glasgow (GB)

Correspondence Address: DASPIN & AUMENT, LLP, 210 WEST 22ND STREET, SUITE 102, OAK BROOK, IL, 60523, US

(21) Appl. No.: 10/571,480

(22) PCT Filed: Sep. 3, 2004
(86) PCT No.: PCT/GB04/03769

§ 371 Date: May 31, 2006

(30) Foreign Application Priority Data
Sep. 10, 2003 (GB) 0321145.5

(51) Int. Cl. G02B 6/12

(52) U.S. Cl. 385/14

(57) ABSTRACT

An optical system for producing an array of single transverse mode laser beam output includes a monolithic laser array (23) having a plurality of outputs (5) in which each laser (4) is adapted for operation so as to produce a single transverse mode output; and an array of waveguides (10), the waveguide array being positioned in relation to the laser array such that each laser output from the laser array couples into an input of a respective waveguide (11) in the waveguide array, the waveguide array maintaining the single transverse mode of each laser output at a respective waveguide output to provide a single transverse mode beam output. Multiple laser arrays (23) be coupled to a single waveguide array (10) enabling the formation of very large arrays and arrays with beam pitch smaller than otherwise possible.

The present invention relates to semiconductor laser arrays for producing plural output beams in a precise array configuration. In particular, though not exclusively, such laser arrays have applicability in telecommunications devices, graphics devices, image transfer devices, imaging and display technologies, solid-state laser pumping and in optical pumping of arrays of vertical cavity surface emitting laser diodes.

A number of systems in the above technical fields require the production of an array of optical spots with at least some of the following characteristics:
(i) output beams in the lowest order transverse mode with a Gaussian beam profile for each spot;
(ii) a well-controlled spot size and beam divergence;
(iii) spots that are located in space with sub-micron precision in two dimensions (x and y) orthogonal to the direction of beam propagation (z);
(iv) a well-controlled mode with respect to the divergence of each beam in the array, the positions of the beam waists and other characteristics along the axes of propagation (z); and
(v) independent control of the optical power in each beam.

For convenience, throughout the present specification, we shall refer to the x-direction as that which is parallel to the plane of the semiconductor laser array substrate and orthogonal to the beam direction; the y-direction as orthogonal to the plane of the substrate and orthogonal to the beam direction; and the z-direction as the direction of beam propagation.

Monolithic arrays of semiconductor lasers fabricated on a single substrate, in which each contiguous element is identical to its neighbour and in which each element is independently controllable, can meet some of these requirements. Such arrays can be integrated into an optical beam delivery system with a small package form-factor. Such a system is, in principle, easy to mass produce and therefore of relatively low cost.

However, as the number of laser elements required in the array increases, element failures occur, the array yield drops and the cost increases significantly. At the present state of technology, it is prohibitively expensive to manufacture arrays of telecom standard lasers because of the difficulty in cleaving to form the laser output facet with the required degree of precision across an entire array. Thus, many of the benefits of laser integration cannot be realised.

As discussed above, many laser array applications require sub-micron alignment accuracy of the output spots in the x and y directions. Fibre bundles have been used as beam delivery systems to couple the output beams of a laser diode array into a downstream optical system, but this approach becomes expensive, bulky and impractical for large laser arrays (eg. arrays comprising more than ten individual laser outputs). Free-space optics can also be used to couple the output beams of the laser diode array into a downstream optical system, but large arrays of micro-optics are difficult to manufacture and there are significant problems associated with alignment of the optics with both the laser diode array and the downstream optical system.

Problems associated with the manufacture of large laser arrays are numerous. If the laser pitch (i.e. the centre-to-centre distance of adjacent lasers in the array) is too small, adjacent lasers will interact thermally (referred to as ‘thermal cross-talk’). This may result in temperature differences across the array. As many laser characteristics, such as threshold current, slope efficiency etc, are dependent on temperature, thermal cross-talk affects the performance of each laser element across the array. This results in unwanted variability in the output spots. In addition, thermal cross-talk can cause beam steering to take place.

After lapping, there may be a ‘smile’ associated with the flatness caused by distortion of the plane of the substrate. This results in deviation in the position of the optical spots from an intended array formation. The cleave quality may not be uniform across an array which results in varying qualities of output beam between individual lasers in the array. Individual elements of the array may exhibit beam steering effects, even when operated alone, arising from thermal effects during operation.

Thus, trade-offs between performance, reliability, yield and cost will determine the maximum number of elements in the array. Primarily, yield and reliability will limit the practical size of the array. In a typical present day telecoms application, laser arrays are practically limited to fewer than 10 laser elements, and cost effective arrays are typically limited to approximately 4 laser elements.

Further limitations arise from packaging of arrays. For example, the packaging process must not interfere with the flatness of the laser array after bonding. This can arise as a result of inadequate flatness of the carrier or from strain and damage during the bonding process.

For large arrays, mechanical and thermal strain and stress during operation of the array can give rise to significant beam misalignments, especially where free-space optics are used to couple the beams into an optical system.

The use of micro-optics systems to couple laser diode outputs to an optical system also gives rise to other problems. For example, each micro-lens has to be aligned with sub-micron precision to a respective laser element across the array. The micro-optics array may have to be custom built, which is expensive and difficult to package. Thermal and/or mechanical shock or other movement during operation can misalign the beams.

WO 02/47915 A1 describes a laser diode array together with a beam delivery system in the form of a beam-shaping micro-light-pipe array. However, the optical system described in WO '915 relates to resolving specific problems with multi-mode lasers, namely ‘filamentation’ or ‘hot-spots’ that result in non-uniform energy distribution in the near field. Specifically, the apparatus described images the multi-mode laser diodes in the array using a ‘micro-light-pipe array’ (MLPA) to achieve spots with evenly distributed energy by ensuring that each beam experiences a number of bounces from the walls of its respective light pipe in the MLPA through which it travels. Due to the multiple reflections, the illumination in each MLP exit aperture is relatively uniform. The light ‘scrambling’ performed by the MLPA inherently excludes single-mode operation. For the reasons discussed above, the apparatus of WO '915 is inherently limited to arrays having only a relatively small number of light pipes. The described light pipes are rods or tubes of transparent material with a polygonal cross-section which cannot be reliably manufactured to the sub-micron dimensions required for a single transverse mode of operation.

It is an object of the present invention to provide a laser diode array that is robust and cost effective. It is a further object of the present invention to provide a laser diode array that can provide a large scale array of, for example, one hundred or more output spots. It is a further object of the present invention to provide a laser diode array that can deliver an array of output beams having sub-micron alignment. It is a further object of the present invention to provide a laser diode array for generating an array of output beams having substantially a single transverse mode.

At least some of the above objects are achieved by the invention as set out in the accompanying claims.

According to one aspect, the present invention provides an optical system comprising:
a monolithic laser array having a plurality of outputs in which each laser is adapted for operation so as to produce a single transverse mode output;
an array of waveguides, the waveguide array being positioned in relation to the laser array such that each laser output from the laser array couples into an input of a respective waveguide in the waveguide array, the waveguide array maintaining the single transverse mode of each laser output at a respective waveguide output to provide a single transverse mode beam output.

According to another aspect, the present invention provides a method for producing an array of laser output beams each having a single transverse mode comprising the steps of:
providing a monolithic laser array having a plurality of outputs in which each laser is adapted for operation so as to produce a single transverse mode output;
positioning an array of waveguides in relation to the laser array such that each laser output from the laser array couples into an input of a respective waveguide in the waveguide array,
the waveguide array maintaining the single transverse mode of each laser output at a respective waveguide output to provide a single transverse mode beam output.

Embodiments of the present invention will now be described by way of example and with reference to the accompanying drawings in which:

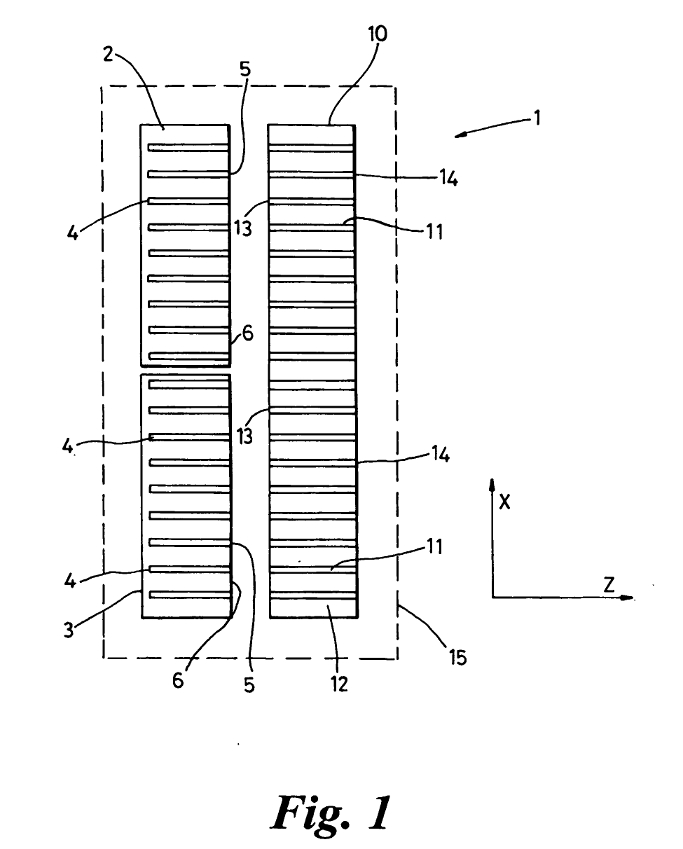

FIG. 1 shows a schematic plan view of an optical system comprising a pair of laser diode arrays and a waveguide array;

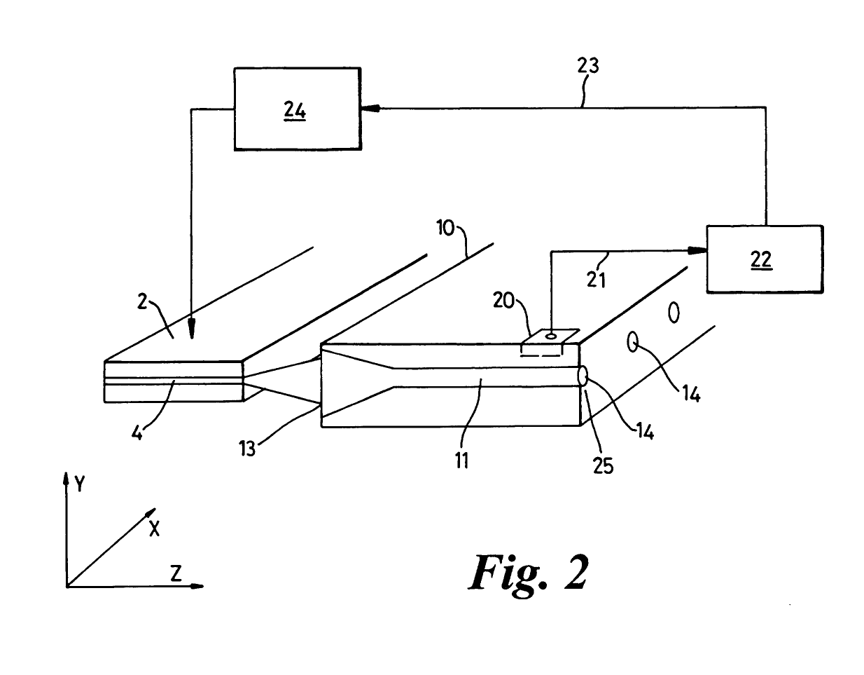

FIG. 2 shows a perspective view of a laser diode array and beam delivery system in the form of a monolithic waveguide array with tapered inputs;

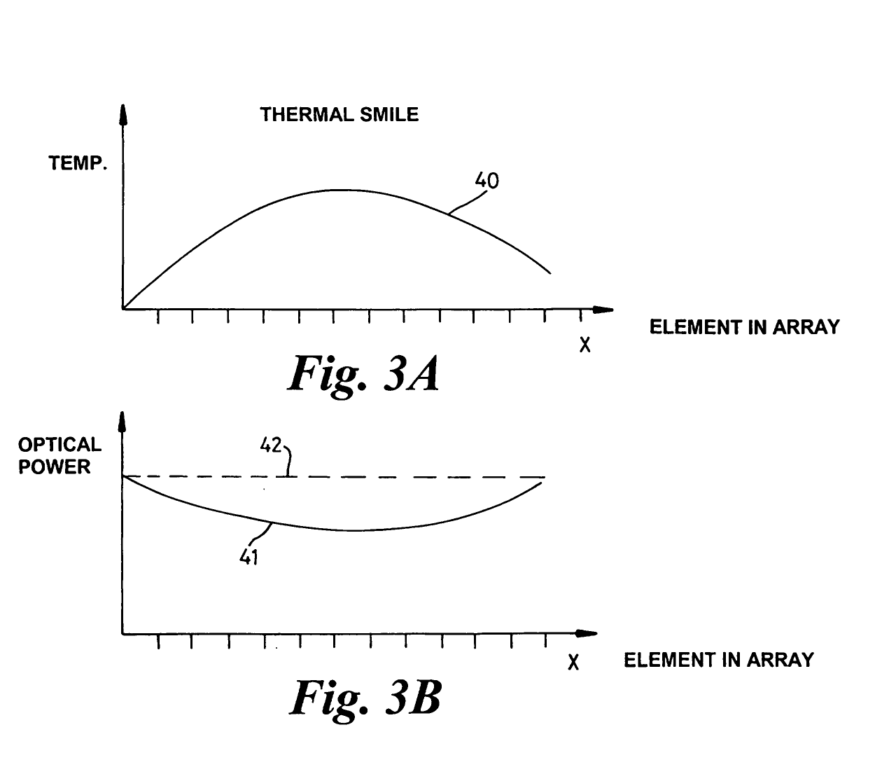

FIG. 3A illustrates the effects of variations in temperature as a function of position of laser diode elements in an array and FIG. 3B illustrates variations in drive power and optical output as a function of position of laser diode elements in an array;

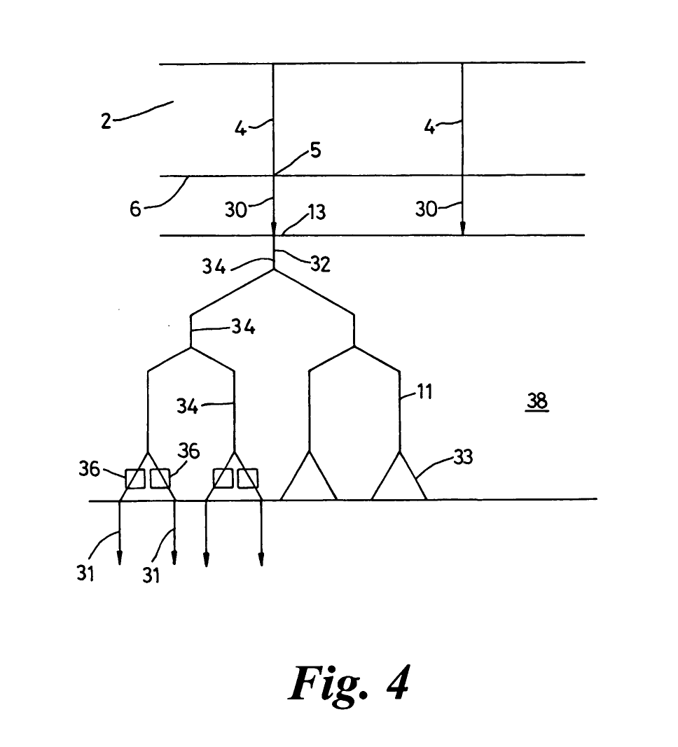

FIG. 4 shows a schematic plan view of a laser diode array and waveguide array having plural outputs for each input;

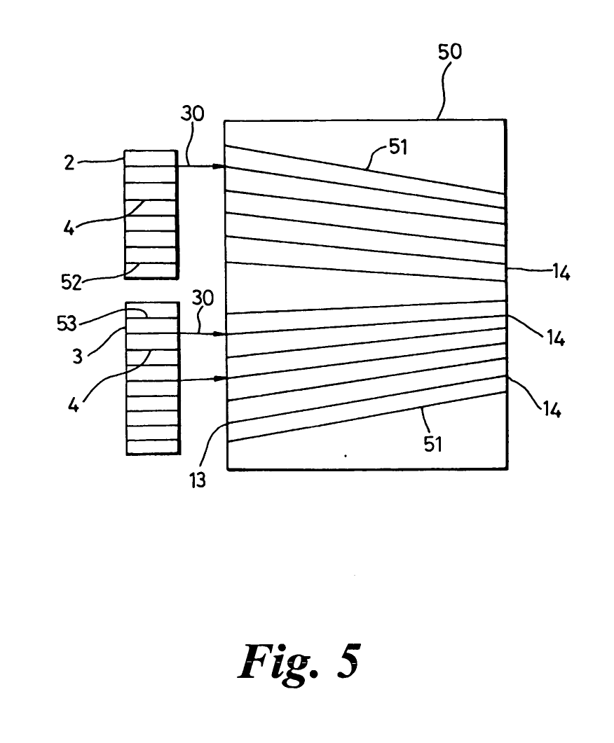

FIG. 5 shows a schematic plan view of a pair of laser diode arrays each coupled into a single waveguide array, the waveguide array effecting a reduction in pitch of the laser diode output beams; and

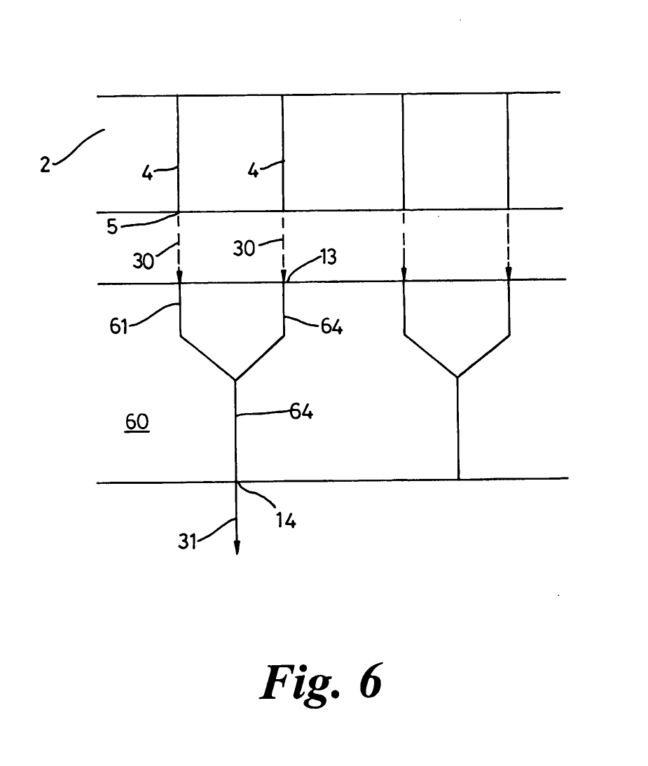

FIG. 6 shows a schematic plan view of a laser diode array and waveguide array having plural inputs for each output.

With reference to FIG. 1, an optical system 1 comprises one or more laser diode arrays 2, 3 each including a plurality of laser diodes 4 each having an optical output 5 in an output facet 6. An array 10 of optical waveguides 11 formed in a single substrate 12 provides a waveguide 11 having an input 13 and an output 14 for each laser diode output 5. The one or more laser diode arrays 2, 3 and the waveguide array 10 are precisely positioned relative to one another on a common substrate 15.

Although only two laser diode arrays 2, 3 are illustrated in FIG. 1, it will be understood that a larger number of laser diode arrays may be used in conjunction with the waveguide array, possibly including a total of over 1000 individual laser diode elements.

Preferably, the common substrate 15 is a packaging substrate to which the laser diode arrays 2, 3 and waveguide array 10 may be bonded using conventional die bonding techniques. Alternatively, the laser diode arrays 2, 3 and the waveguide array 10 may be fabricated together on a common substrate. Preferably, a single monolithic structure is used to provide the waveguide array 10. Alternatively, the waveguide array may be provided as two or more waveguide arrays each bonded to the common substrate 15 and precisely positioned relative to a respective one of the one or more laser diode arrays.

Each of the laser diodes 4 in the arrays 2, 3 is adapted to operate in a single transverse mode of operation. Each of the waveguides 11 in the waveguide array 10 is particularly adapted to maintain, at the outputs 14 thereof, the single transverse mode of any optical beams presented at the inputs 13 thereof.

A single transverse mode in the waveguides can be sustained by appropriate selection of refractive index contrast and thickness of materials.

Also, to sustain the single transverse mode at the waveguide outputs by positioning each laser diode array 2, 3 in relation to the waveguide array 10 with sub-micron registration accuracy using conventional bonding and positioning techniques.

With reference to FIG. 2, the ease of alignment of the or each laser diode array 2 with the respective waveguide array 10 may be significantly improved by the formation of a tapered section at the waveguide input 13 such that the diameter of each waveguide input 13 is greater than the diameter of each waveguide output 14. As shown in the example, the taper may extend only a short distance into the waveguide. The taper may exist in either the x or y direction, or both for easing both lateral and vertical alignment.

Each waveguide 11 may include mode filters and beam shapers to take into account any mode instabilities and beam steer that might otherwise occur across the array during operation. Examples of such mode filters include, for example, a tapered structure to filter out any tendency to multimode operation. In another example, a beam shaper may be incorporated to convert an elliptical optical beam output of a laser into a circular beam by providing a waveguide channel that allows one axis to expand slightly.

In one arrangement, the waveguide array 10 may include a number of photodiode structures 20 for monitoring power output of a respective waveguide 11. Each photodiode structure is coupled to a feedback loop 21 including a sensing circuit 22 for determining the power output. The sensing circuit 22 supplies a control signal 23 to a drive circuit 24 used to power the laser diode array 2. The feedback loop thereby enables the laser diode drive circuit 24 to tune the power output of each laser diode 4 in the array 2 to maintain a substantially constant power output from the or each element in the array.

Thereby, variations in optical output as a function of transverse (x) position in the array may be reduced, minimised or eliminated. For example, with reference to FIG. 3A, in a conventional laser diode array, heat dissipation characteristics of the laser diodes in the array typically result in a temperature profile 40 that increases towards the centre of the array and decreases towards the lateral edges of the array. In other words, the temperature varies as a function of x-position. If no action is taken to correct this, an inevitable result will be a decrease in optical power output towards the centre of the array, as shown in FIG. 3b, profile 41.

However, the drive current or electrical power delivered to each laser diode element in the array 2 may be adjusted to modify the profile by virtue of the respective feedback loops and thereby maintain a profile 42 that is constant across the transverse (x) direction.

Preferably, a photodiode structure 20 and associated feedback loop 21 is provided for each waveguide 11 and each corresponding laser diode 5 for maximum control. However, it will be understood that variations in beam outputs as a function of transverse (x) position in the array may be at least reduced by providing photodiode structures 20 periodically across the array, with laser diodes being grouped to correspond to the closest photodiode structure and controlled accordingly.

Each waveguide output 14 may include a lens structure 25 to collimate or focus the optical output therefrom into a downstream optical system. Such lens structures 25 may preferably be integrated into the monolithic structure of the waveguide 10 using known thin-film processing techniques.

With reference to FIG. 4, the waveguide array 38 may be configured to divide each or some of the laser diode 5 outputs 30 into a plurality of distinct output beams 31. This is achieved by fabricating the waveguide array 10 to include a plurality of output paths 33 for each respective input path 32. As illustrated, this may be provided by way of a waveguide 11 comprising a plurality of sections 34 which divide in a ‘binary tree’ configuration.

This configuration provides a number of benefits. In an illustrative example, each single mode laser element 4 provides an output beam 30 of power 100 mW and this beam is coupled into a waveguide 11 which waveguide sub-divides three times to produce a 1 to 8 output for each single laser element 4.

This gives 12.5 mW per output beam 31 (ignoring small losses). In this manner, a ten-element laser array 2 having 500 micron pitch (centre-to-centre distance of elements in the laser diode array) can be converted to an eighty-element array with optical outputs having a 62.5 micron pitch. Each of the waveguides 11 may be provided with a modulator 36 to individually address and modulate each optical output 31. In this manner, very large arrays can be constructed of more than 100 laser elements.

With reference to FIG. 5, the optical waveguide array 50 may be configured to reduce the pitch of the output beams 30 from the laser diode array or arrays 2, 3. In this configuration, each of the waveguides 51 extends generally in the beam propagation direction (z) but the waveguides 51 are presented at slightly varying angles to the z-direction in order to provide a degree of convergence of the varying beams passing therethrough. In this way, the waveguide array 50 acts as a pitch reduction waveguide. In a general sense, the waveguide array includes a plurality of inputs 13 having a first pitch and a corresponding plurality of outputs 14 having a second pitch, in which the first pitch is greater than the second pitch. The waveguides can be straight, as shown, or could be curved or angled to provide the pitch change.

This configuration of waveguide array 50 is particularly useful where the laser diode array 2, 3 cannot be manufactured with a pitch sufficiently small to meet the requirements of the application. This configuration also enables a laser diode array to be manufactured with a pitch that is somewhat greater than that otherwise suggested by the performance requirements of the application, which has beneficial effects on power dissipation, and reduction of cross-talk between adjacent devices. This configuration may also assist in maintaining a suitable bond pad size on the laser diode array.

As shown in FIG. 5, this configuration of array 50 is also particularly useful where plural laser diode arrays 2, 3 are used in conjunction with the waveguide array 50. The gap between the end laser diode elements 52, 53 respectively of adjacent arrays 2, 3 is clearly greater than the standard pitch of the devices 4 within each array because of the edges of the substrate of the laser arrays. The effects of this extra gap can be reduced or eliminated entirely by an appropriate taper of the corresponding waveguides 51 so that the waveguide outputs 14 have a regular pitch.

The laser array size may thereby be optimised in terms of performance, reliability and cost for a particular application. The use of multiple laser arrays coupled into a single waveguide to give a very large array means that smaller laser arrays 2, 3 can be used with consequent improvements in yield, performance and reliability.

It will be understood that although the embodiment of FIG. 5 illustrates a pitch reduction waveguide, the effect of the waveguide could be reversed to provide a pitch expansion waveguide (not shown). In a general sense, the waveguide array may include a plurality of inputs having a first pitch and a corresponding plurality of outputs having a second pitch, in which the first pitch is less than the second pitch.

With reference to FIG. 6, the waveguide array 60 may be configured to combine the optical power of the outputs 5 of several laser diodes 4 into a single output beam 31. This is achieved by fabricating the waveguide array 60 to include a plurality of input paths 61 for each respective output path 31. As illustrated, this may be provided by way of a waveguide 60 comprising a plurality of sections 64 which combine in a ‘binary tree’ configuration. In an extreme case, all of the plurality of input paths 61 could be linked to converge on a single output path section 64 to provide a very high power single mode optical beam output 31.

The configuration of FIG. 6 may be used to improve the yield and reliability of an optical system. The system may be initially configured such that only one laser diode in each adjacent pair is operational. If, during initial characterisation, testing or operation of the system, it becomes apparent that one of the laser pairs is non-functional, the other laser of the pair may be switched in.

The optical waveguide arrays are preferably optically passive, ie. not electrically driven to amplify or modulate light passing therethrough. However, optically active structures (e.g. for modulation) could be incorporated therein.

The optical waveguide arrays are preferably fabricated such that light mainly propagates only in the lowest order or fundamental transverse mode of the waveguide. The waveguides may be capable of supporting higher order modes, in which case either the launch optics or mode filters (or both) are designed to ensure optical power propagates substantially only in the fundamental transverse mode.

The waveguide arrays may be fabricated substantially in ferro-electric materials such as lithium niobate or lithium tantalate using conventional techniques including epitaxy, diffusion of ions including Ti or protons to modify the refractive index, etching etc.

The waveguide arrays may be fabricated substantially in silicon, silicon dioxide, silicon nitride or other dielectric materials. The waveguide arrays may be fabricated in III-V materials or other semiconductors. The waveguide arrays may be fabricated with hollow waveguides, clad with metal or other materials, in which the light is confined substantially to the hollow region.

The waveguide arrays may include passive waveguide platforms in which optical elements such as lenses, mode filters and photodiodes are located within the passive waveguides.

Although the waveguide arrays and laser arrays described have been illustrated with elements extending in the x direction, but with only one element extent in the y direction, it will be understood that the laser and waveguide elements may extend in y direction also to provide a full two dimensional array.

Other embodiments are intentionally within the scope of the accompanying claims.

1. An optical system comprising:
a monolithic laser array having a plurality of outputs in which each laser is adapted for operation so as to produce a single transverse mode output;
an array of waveguides, the waveguide array being positioned in relation to the laser array such that each laser output from the laser array couples into an input of a respective waveguide in the waveguide array, the waveguide array maintaining the single transverse mode of each laser output at a respective waveguide output to provide a single transverse mode beam output.

2. The optical system of claim 1 further including a plurality of monolithic laser arrays each having a plurality of outputs in which each laser is adapted for operation so as to produce a single mode output, and each laser output of the plural monolithic arrays couples into an input of a respective waveguide in the waveguide array.

3. The optical system of claim 1 in which the or each monolithic laser array and the waveguide array are mounted on a common package substrate.

4. The optical system of claim 1 further including means, in the waveguide array for independently controlling the power output of at least some of the waveguides.

5. The optical system of claim 1 in which the waveguide inputs of the waveguide array have a first pitch and the waveguide outputs of the waveguide array have a second pitch.

6. The optical system of claim 5 in which the first pitch is greater than the second pitch.

7. The optical system of claim 1 in which the number of laser outputs optically coupled to a single waveguide output is greater than one.

8. The optical system of claim 7 in which at least some of the laser outputs are separately switchable.

9. The optical system of claim 1 further including a lens element optically coupled to each waveguide output.

10. The optical system of claim 1 in which each waveguide in the waveguide array splits such that each waveguide input corresponds to plural waveguide outputs while capable of maintaining a single mode output at each waveguide output.

11. The optical system of claim 1 in which each waveguide in the waveguide array splits such that plural waveguide inputs correspond to a single waveguide output while capable of maintaining a single mode output at each waveguide output.

12. The optical system of claim 1 in which the waveguide array includes a mode filter in at least some of the waveguides.

13. The optical system of claim 1 in which the waveguide array includes a beam shaper in at least some of the waveguides.

14. The optical system of claim 1 in which the waveguide array includes a photodiode associated with at least some of the waveguides adapted to monitor power output from the respective waveguide.

15. The optical system of claim 1 in which the inputs of the waveguides in said waveguide array include a tapered section such that the or a diameter of the waveguide input is greater than the or a diameter of the output.

16. The optical system of claim 1 in which each waveguide in the waveguide array has at least a portion thereof having a lateral dimension transverse to the direction of beam propagation which is 1 micron or less.

17. The optical system of claim 1 in which the waveguide array is formed on a single semiconductor substrate.

18. The optical system of claim 17 in which each waveguide in the array is formed by locally varying the refractive index in the semiconductor substrate using photolithographic techniques.

19. The optical system of claim 18 in which each waveguide in the array is formed using quantum well intermixing.

20. The optical system of claim 1 further including a plurality of waveguide arrays, each waveguide array being positioned in relation to the laser array such that each laser output couples into an input of a respective waveguide in the plurality of waveguide arrays, each waveguide maintaining the single transverse mode of each laser output at a respective waveguide output to provide a single transverse mode output thereat.

21. The optical system of claim 1 in which the laser array is a laser diode array.

22. The optical system of claim 14 further including a feedback loop between the or each photodiode and a drive circuit controlling the laser array.

23. A method for producing an array of laser output beams each having a single transverse mode comprising the steps of:
providing a monolithic laser array having a plurality of outputs in which each laser is adapted for operation so as to produce a single transverse mode output;
positioning an array of waveguides in relation to the laser array such that each laser output from the laser array couples into an input of a respective waveguide in the waveguide array,
the waveguide array maintaining the single transverse mode of each laser output at a respective waveguide output to provide a single transverse mode beam output.

24.-25. (canceled)
